(19) United States
(12) Patent Application Publication
(10) Pub. No.: US 2007/0015479 A1
(43) Pub. Date: Jan. 18, 2007

(54) Integrated wireless receiver and a wireless receiving method thereof

(76) Inventors: Joonbae Park, Seoul (KR); Seung Wook Lee, Seoul (KR); Jeong Woo Lee, Seoul (KR); Kyeongho Lee, Seoul (KR)

Correspondence Address: FLESHNER & KIM, LLP, P.O. BOX 221200, CHANTILLY, VA, 20153, US

(21) Appl. No.: 11/272,053

(22) Filed: Nov. 14, 2005

(30) Foreign Application Priority Data
Nov. 19, 2004 (KR) 10-2004-0095374

(51) Int. Cl. H04B 1/18

(52) U.S. Cl. 455/179.1

(57) ABSTRACT

A wireless receiver and a wireless receiving method are provided wherein a frequency of a radio frequency (RF) is down-converted into a frequency of a substantially zero intermediate frequency (IF) signal or a substantially low IF signal. The down-converted signal may be filtered by an integrated filter having a low quality factor and then up-converted again into a particular IF signal, thereby integrating an external element. For example, a receiving device may receive a RF signal in a required band. A frequency down-converting device may down-convert a frequency so that a center frequency of the RF signal becomes zero. A channel select filtering device may select a required channel from the signals whose frequency is down-converted. An IF signal converting device may up-convert a frequency of the channel selected signal into a required IF. An IF processing device may extract a baseband signal after the converted IF signal is inputted and processed. An amplifying device may amplify a signal with a gain required in a process of converting a frequency.

This application claims priority from Korean Application No. 10-2004-0095374, filed Nov. 19, 2004, the disclosure of which is incorporated herein by reference.

### BACKGROUND OF THE INVENTION

1. Field

Embodiments of the present invention may relate to a wireless receiver and a wireless receiving method thereof. More particularly, embodiments of the present invention may relate to a wireless receiver and a wireless receiving method thereof wherein an external element may be integrated using a substantially zero intermediate frequency (IF) or a substantially low IF. This may make the wireless receiver compatible with an super-heterodyne interface.

2. Background of Related Art

FIG. 1 is a diagram of a wireless communication system according to an example arrangement. Other arrangements are also possible. As shown in FIG. 1, a signal generated by a transmitter 100 may be spread in the air and transmitted to a receiver 200. Many other noises and signals may be transmitted in the air by other people.

The transmitter 100 may send a signal of a proper electric power so that the receiver 200 can receive the transmitted signal. The transmitter 100 may not emit any frequency components except the frequency used in the transmitter 100. When using various frequency channels, the transmitter 100 may send the signals without interference among them.

The receiver 200 may amplify electric power of a weak signal transmitted from the transmitter 100 and prevent other noises in the air. Also, when using various frequency channels, the receiver 200 may select only the required channel.

The receiver 200 may operate based on a superheterodyne method using an intermediate frequency (IF). The superheterodyne method may be a method in which a carrier frequency is not directly converted into a baseband frequency but rather may be processed after it is converted into a certain frequency in a middle of the process.

FIG. 2 is a block diagram of a superheterodyne receiver according to an example arrangement. Other arrangements are also possible. As shown in FIG. 2, the receiver 200 may include an antenna 210, a band select filter 220, a low-noise amplifier (LNA) 230, an image reject filter 240, a down-mixer 250, a channel select filter 280 and an IF processor 280. The antenna 280 may receive a radio frequency (RF) signal. The band select filter 220 may filter a signal in a particular band and the low-noise amplifier 230 may amplify a signal while preventing noise amplification. The image reject filter 240 may prevent an image frequency from being transmitted to the mixer 250. The down-mixer 250 may convert a low-noise amplified RF signal into an IF signal. The channel select filter 280 may select a particular channel from the signal converted into the IF. The IF processor 290 may process the IF signal in the selected channel.

The down-mixer 250 may mix the RF signal with an oscillating frequency fLO inputted from a local oscillator 260, thereby converting the RF signal into the IF signal. The oscillating frequency fLO may be stabilized by a phase-locked loop (PLL) 270.

FIG. 3 shows graphs illustrating a frequency conversion process according to an example arrangement. Other arrangements are also possible. This frequency conversion process may include converting the low-noise amplified RF into an IF in the receiver as described in FIG. 2. FIG. 3 shows a center frequency of a carrier as fC, and there exist spectra of a RF signal centering on fC. If such a RF signal is mixed with fLO oscillated from the local oscillator 260, and down-converted, the RF signal may be converted into the IF signal having a center frequency fIF. The IFs may be different depending on the type of wireless communication equipment. For example, a radio may use an IF of 10.7 MHz, a television may use an IF of 45 MHz and satellite equipment may use an IF of 160 MHz.

Since the converted IF signal is converted into a baseband signal by the IF processor 290, the baseband signal carried in the original carrier wave may be extracted. An analog process may be implemented from another end of the IF processor 290. Alternatively, a digital process may also be implemented by converting an analog signal into a digital signal from the other end of the IF processor 290.

As described above, the wireless communication receiver may use a superheterodyne method in which a RF signal is not directly converted into a baseband signal but rather is down-converted into the baseband signal after it is converted into an IF.

These are reasons for providing an IF processor between a RF processor and a baseband processor. For example, since a filter having a high quality factor may be required for filtering a particular band in a RF signal, it may be difficult to design such a delicate filter. Technologically, it is may be more economical to convert a RF signal into an IF signal and to use a filter having a lower quality factor than to design a filter having a higher quality factor and to process a signal in an RF band.

As another example, an IF processor may be provided between a RF processor and a baseband processor, thereby preventing various frequency fluctuations or abnormalities of the RF processor from being transmitted to the baseband processor. As another example, if an IF signal is not used before a RF signal is inputted to a baseband processor, all the signals may be amplified in an RF signal. However, if this amplification process is concentrated on a part of a system, the system may become unstable.

As an even additional example, by providing the IF processor, a system next to the terminal of an IF processor may be used in common although a carrier frequency may be different, thus enabling economic designing of a receiver.

However, regardless of such advantages, if an IF signal is used, interference by an image frequency may result. An image frequency (i.e., an image signal) may be a signal located symmetrically with a RF signal required to receive, centering on fLO, which is an oscillating frequency of a local oscillator. Also, the image frequency may cause a receiver a critical result by directly disturbing an IF signal. Therefore, in order to remove the image frequency in a superheterodyne receiver, a separate image reject filter 240 may be provided at a front terminal of the down-mixer 250 to remove the image frequency being input to the mixer 250.

There has been a tendency to integrate many elements, thereby decreasing the number of external elements for the sake of the miniaturization and lightness of wireless receivers. The integration of elements has been increased along with the development of process technology.

A surface acoustic wave (SAW) filter or a ceramic filter used in the above-described superheterodyne receiver may be an ideal filter available for attenuating blocking signals except for particular signals, but it may be practically very difficult to embody an integrated filter with such characteristics.

In particular, the performance of integrated filters has been improved as much as it can as compared with surface acoustic wave (SAW) filters. However, it may be easy to implement low-pass filters (LPFs) or band-pass filters (BPFs) having a low quality factor in a proper die area, while it may be difficult to design filters having a high quality factor. Practically, the quality factor of BPFs, which may be required for filtering an IF signal, may be very high, while it is very complex and uneconomic to implement quality factor of more than two (2) with integrated filters. Thus, a new approach may integrate external elements of a wireless receiver.

### SUMMARY

Embodiments of the present invention may provide a wireless receiver that includes a receiving means receiving a RF signal in a required band and a frequency down-converting means down-converting a frequency such that a center frequency of the RF signal becomes substantially zero; and a channel select filtering means selecting a required channel from the signals whose frequency is down-converted. The wireless receiver may also include an intermediate frequency (IF) signal converting means up-converting a frequency of the channel selected signal into a required IF, an IF processing means extracting a baseband signal after the converted IF signal is inputted and processed, and an amplifying means amplifying a signal with a gain required in a process of converting a frequency.

Embodiments of the present invention may also provide a wireless receiver that includes a receiving means receiving a RF signal in a required band, a frequency down-converting means down-converting a frequency so that the center frequency of the RF signal becomes a substantially low IF near zero, and a channel select filtering means selecting a required channel from the signals whose frequency is down-converted. The wireless receiver may also include an IF signal converting means up-converting a frequency into a required IF in the channel selected signal, an IF processing means extracting a baseband signal after the converted IF signal is inputted and processed, and an amplifying means amplifying a signal with a gain required in a process of converting a frequency.

Embodiments of the present invention may provide a wireless receiver that includes an antenna receiving a RF signal, a band select filter selecting a required band in the received RF signal, and an amplifier low-noise amplifying the band selected signal. The wireless receiver may further include a frequency down-converter converting the low-noise amplified RF signal into a substantially zero IF signal or a substantially low IF signal, an integrated channel select filter selecting a required channel from the signals whose frequency is down-converted, and an automatic gain controller controlling a gain of the channel selected signal. The wireless receiver may also include a frequency up-converter up-converting the channel selected signal into a required IF signal, and an IF processor extracting a baseband signal after the signal that is up-converted by the required IF is inputted and processed.

Embodiments of the present invention may also provide a wireless receiving method that includes receiving a RF signal in a required band, down-converting a frequency so that the center frequency of the RF signal becomes substantially zero, and selecting a required channel in the signals in which the frequency is down-converted. The wireless receiving method may additionally include up-converting a frequency into a required IF in the channel selected signal, extracting a baseband signal after the converted IF signal is inputted and processed, and amplifying a signal with a gain required in a process of converting a frequency.

Embodiments of the present invention may provide a wireless receiving method that includes receiving a RF signal in a required band, down-converting a frequency so that the center frequency of the RF signal becomes a low IF such as near zero, and selecting a required channel from the signals whose frequency is down-converted. The wireless receiving method may additionally include up-converting a frequency into a required IF in the channel selected signal, means extracting a baseband signal after the converted IF signal is inputted and processed, and amplifying a signal with a gain required in a process of converting a frequency.

Embodiments of the present invention may provide a wireless receiving method that includes receiving a RF signal, selecting a required band in the received RF signal, and low-noise amplifying the band selected signal. The wireless receiving method may also include converting the low-noise amplified RF signal into a substantially zero IF signal or a substantially low IF signal, selecting a required channel from the signals whose frequency is down-converted, and controlling a gain of the channel selected signal. The wireless receiving method may still further include up-converting the channel selected signal into a required IF signal, and extracting a baseband signal after the signal is up-converted by the required IF and is inputted and processed.

Other objects, features, advantages and salient features of embodiments of the present invention may become more apparent from the following description taken in conjunction with the annexed drawings.

### BRIEF DESCRIPTION OF THE DRAWINGS

Arrangements and embodiments of the present invention will be described in detail with reference to the following drawings in which like reference numerals refer to like elements and wherein:

FIG. 1 is a diagram of a wireless transceiver according to an example arrangement;

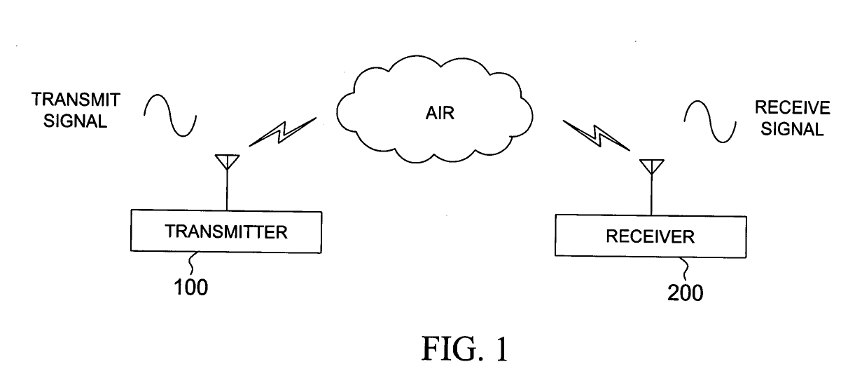

FIG. 2 is a block diagram of a superheterodyne receiver according to an example arrangement;

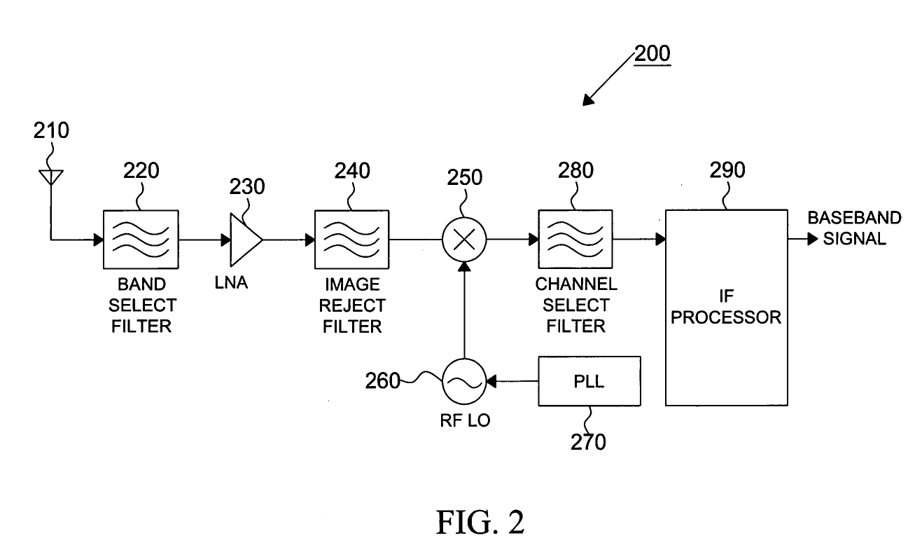

FIG. 3 shows graphs illustrating a frequency conversion process according to an example arrangement;

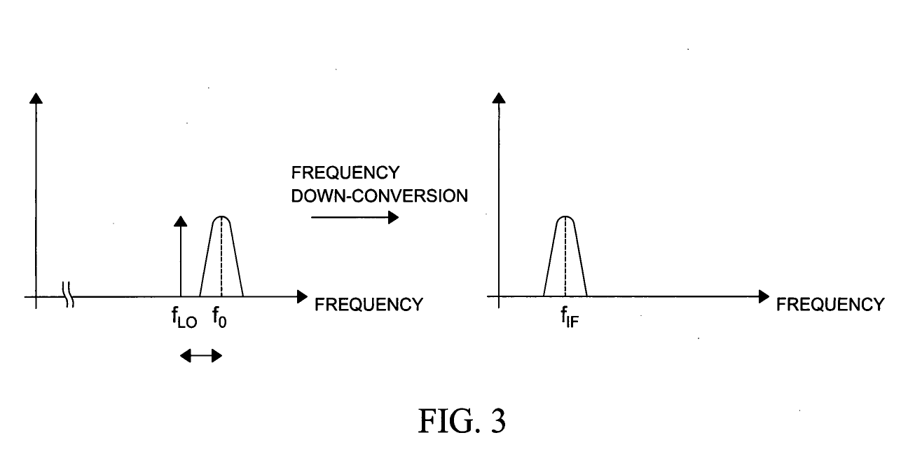

FIG. 4 is a block diagram of a wireless receiver according to an example embodiment of the present invention;

FIG. 5 is a flow chart showing processing the RF signal received by the integrated receiver of FIG. 4 according to an example embodiment of the present invention;

FIG. 6 shows graphs illustrating the process of down-converting a RF signal into a substantially zero intermediate-frequency (IF) signal according to an example embodiment of the present invention; and

FIG. 7 shows graphs illustrating the process of filtering after converting a RF signal into a low IF signal according to an example embodiment of the present invention.

### DETAILED DESCRIPTION

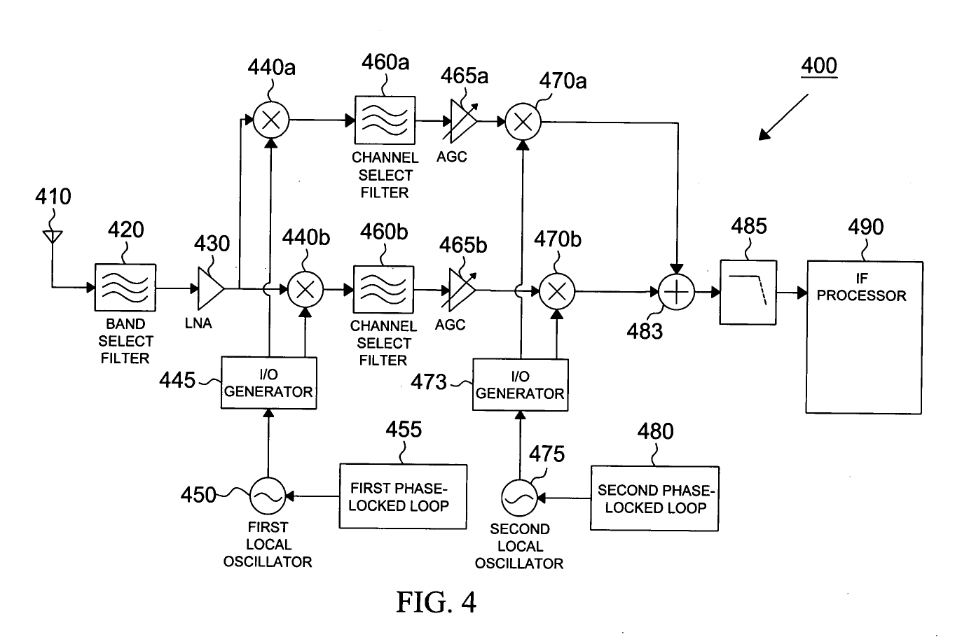

FIG. 4 is a block diagram of a wireless receiver according to an example embodiment of the present invention. Other embodiments and configuration are also within the scope of the present invention. More specifically FIG. 4 shows that the integrated receiver may include an antenna 410, a band select filter 420, a low-noise amplifier (LNA) 430, down-mixers 440a and 440b, channel select filters 460a and 460b, automatic gain controller (AGC) 465a and 465b, up-mixers 470a and 470b, an adder 483, a low pass filter (LPF) 485, and an IF processor 490.

The antenna 410 may receive a RF signal. The band select filter 420 may selectively filter only the frequency of a required band in the received RF signal. The low-noise amplifier (LNA) 430 may amplify a signal of the required frequency band. The down-mixers 440a and 440b may down-convert a frequency into a substantially zero IF or a substantially low IF. Still further, the channel select filters 460a and 460b may select a required channel. The automatic gain control (AGCs) 465a and 465b may control a gain of the channel selected signal. The up-mixers 470a and 470b may up-convert a frequency and the adder 483 may add an in-phase (I) channel signal and a quadrature (Q) channel signal. The low pass filter (LPF) 485 may filter a signal except for a required IF signal, and the IF processor 490 may process the filtered IF signal.

The receiver 400 may include a first local oscillator 450 and a first phase-locked loop (PLL) 455 oscillating a reference frequency signal f₁ in order to down-convert the frequency of an inputted RF signal. The receiver 400 may also include an I/Q generator 445 generating an I channel signal and a Q channel signal.

Also, the receiver 400 may include a second local oscillator 475 and a second PLL 480 oscillating a reference frequency signal f₂ in order to up-convert the frequency of the channel selected signal after the frequency is down-converted. The receiver 400 may additionally include an I/Q generator 473 generating an I channel signal and a Q channel signal.

Since the channel select filters 460a and 460b and the LPF 485 have a low quality factor, the elements may be integrated.

The band select filter 420 may filter received signals by selectively passing a required frequency band signal from the signal received from the antenna 410. When using several channels, all the channels may pass through the filter 420 and in case of transmitting and receiving a signal with the same antenna 410, a duplexer (not shown) may be included to replace the function of the band select filter 420.

The LNA 430 may amplify the received RF signal and prevent noise in the RF signal in which noises in the air are incoming together.

The down-mixers 440a and 440b may down-convert the frequency of an inputted RF signal based on the reference frequency f₁ oscillated from the first local oscillator 450. The frequency oscillated from the first local oscillator 450 may be the same as or substantially the same as the RF signal. Therefore, the down-converted frequency may become a substantially zero IF or a substantially low IF. In addition, the I/Q generator 445 may divide the signal oscillated from the first local oscillator 450 into an I channel signal and a Q channel signal by providing a phase difference of 90°, and then provide the signals for each of the down-mixers 440a and 440b.

The channel select filters 460a and 460b may selectively filter only the required channel from signals whose frequency is down-converted. Since the signal whose frequency is down-converted is a substantially zero IF or a substantially low IF, these features may be implemented by a filter having a low quality factor. In other words, the quality factor may be defined as a ratio of a center frequency and a pass bandwidth. Since the signals whose frequency is down-converted by the down-mixers 440a and 440b have a much lower center frequency, it may be possible to sufficiently filter the required channel with the filter having a low quality factor and to implement such channel select filters 460a and 460b with an integrated filter.

Since embodiments of the present invention may use a substantially zero IF signal or a substantially low IF signal, an image reject filter may not be used when a high quality factor is required.

The up-mixers 470a and 470b may up-convert the frequency of a substantially zero IF signal or a substantially low IF signal based on the reference frequency signal f₂ oscillated from the second local oscillator 475. For example, in a wireless receiver such as a radio, if an input frequency for the IF processor 490 is 10.7 MHz, the up-mixers 470a and 470b may up-convert a substantially zero IF signal or a substantially low IF signal into an IF signal having the frequency of 10.7 MHz.

The up-mixers using the I/Q channels may be a single sideband mixer. The up-mixers may be implemented using not only an analog mixer but also a digital mixer. In order to implement such features using the digital mixer, an analog-to-digital converter (ADC) may be provided at an input end of the digital up-mixers 470a and 470b, and a digital-to-analog converter (DAC) may be provided at an output end of the digital up-mixers 470a and 470b. The digital mixer may be used as the up-mixers 470a and 470b, thereby improving quality of linearity and dynamic range.

On the other hand, the reference frequency oscillated from the second local oscillator 475 may be the same as or substantially the same as an input frequency for the IF processor 490. For example, in a wireless receiver such as a radio, if an input frequency for the IF processor 490 is 10.7 MHz, the up-mixers 470a and 470b may up-convert a substantially zero IF signal or a substantially low IF signal into an IF signal having the frequency of 10.7 MHz.

Further, the I/Q generator 473 may divide the signal oscillated from the second local oscillator 475 into an I channel signal and a Q channel signal by giving it a phase difference of 90°, and then provide the signals for each up-mixer 470a and 470b.

The I channel signal and the Q channel signal of which the frequency is up-converted by the up-mixers 470a and 470b may be added by the adder 483 and then input to the LPF 485.

The LPF 485 may filter the IF signal whose frequency is up-converted, thereby removing intermodulation distortion (IMD) generated in the mixing process. In the same way, since the LPF 485 may be replaced by a filter having a low quality factor, this may be implemented as an integrated filter. The LPF 485 may be replaced by a band pass filter (BPF) in accordance with the required IF band.

The IF processor 490 may process an IF signal inputted in the same way as the IF signal processor of a superheterodyne receiver. An analog process may be implemented from the other end of the IF processor 490. Alternatively, a digital process may also be implemented by converting an analog signal into a digital signal from the other end of the IF processor 490.

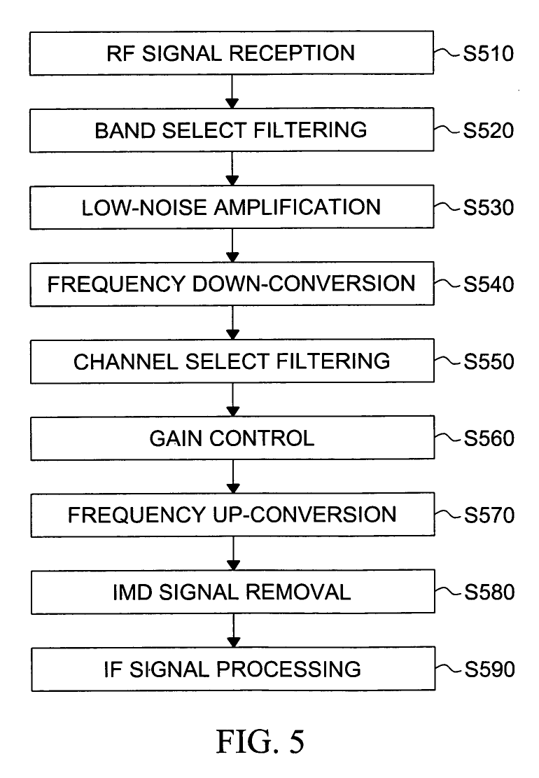

FIG. 5 is a flow chart showing processing the RF signal received by the integrated receiver of FIG. 4 according to an example embodiment of the present invention. Other embodiments, operations and orders of operation are also within the scope of the present invention. As shown in FIG. 5, if a RF signal is received through the antenna 410, the band select filter 420 may selectively pass only the required frequency band (S510, S520). For instance, since a Bluetooth receiver uses the frequency of 2.4 GHz as a carrier frequency, the band select filter 420 may selectively filter the frequency near the band of 2.4 GHz.

The band-pass-filtered RF signal may be low-noise amplified by the LNA 430, and its frequency may be down-converted by the down-mixers 440a and 440b (S530, S540). The oscillating frequency for down-converting frequency may be the same as (or substantially the same) as the inputted RF signal so that the converted frequency becomes a substantially zero IF. For example, a Bluetooth receiver may use the oscillating frequency of 2.4 GHz so that the center frequency of the signal converted by the down-mixers 440a and 440b becomes zero.

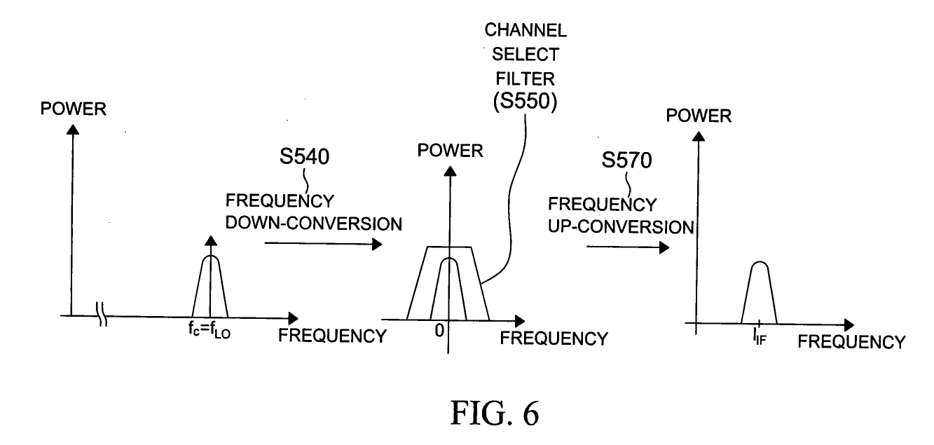

FIG. 6 shows graphs illustrating the process of down-converting a RF signal into a substantially zero IF signal according to an example embodiment of the present invention. Other embodiments are also within the scope of the present invention. More specifically, FIG. 6 shows that a frequency fLO, which is the same as the center frequency fC of the RF signal, is oscillated such that the center frequency of the down-converted spectra corresponds with a substantially zero frequency. If the zero IF is used in this way, only the image frequency for its own signal is considered, and no separate image reject filter may be needed.

Further, a direct current (DC) offset that may occur when the zero IF is used may be resolved by a direct conversion technology (i.e., not using an IF signal but directly converting a RF signal into a baseband signal). In other words, in communications using time slots such as Global System for Mobile Communications (GSM), the DC offset may be resolved by discharging DC electric charges during the time when communication is not kept. In a wireless local area network (LAN), the DC offset may be resolved by preventing a signal from being carried in a DC frequency area.

The channel select filters 460a and 460b may filter only a required channel with an integrated filter having a low quality factor for the signal whose frequency is down-converted into a substantially zero IF. As described above, the filter having a low quality factor may filter only the required channel in a low frequency band (S550).

The automatic gain controllers 465a and 465b may amplify the channel-select filtered signal with a proper gain, and the frequency of the amplified signal may be up-converted by the up-mixers 470a and 470b (S560, S570). In order to up-convert the frequency, the second local oscillator 475 may oscillate the required frequency, and the second phase-locked loop 480 may securely lock the oscillating frequency of the second local oscillator 475.

The frequency oscillated from the second local oscillator 475 may be changed in accordance with the process of the IF processor 490. In other words, if an IF of 10.7 MHz is used such as for a receiver of a radio, the second local oscillator 475 may oscillate the frequency of 10.7 MHz in a same way as the operational frequency of the radio receiver, and then the frequency of a substantially zero IF signal may be up-converted into the frequency of 10.7 MHz by the up-mixers 470a and 470b to which the oscillating frequency of 10.7 MHz is inputted.

An IMD signal in the signal whose frequency is up-converted into an IF may be removed by the LPF 485 and then the signal in which the IMD signal is removed may be inputted to the IF processor 490 (S580, S590). Since the process of the signal inputted to the IF processor 490 may be the same as that of the above-described superheterodyne method, a further description will not be provided.

According to another embodiment of the present invention, the received RF signal may be converted into a substantially low IF, not a substantially zero IF for processing. Particularly, since in wireless application such as Personal Handyphone System (PHS), Bluetooth or the like, there may be no blocking signal in a frequency channel adjacent to a required channel, an image frequency may be left out of consideration even though the received RF signal is converted into a substantially low IF.

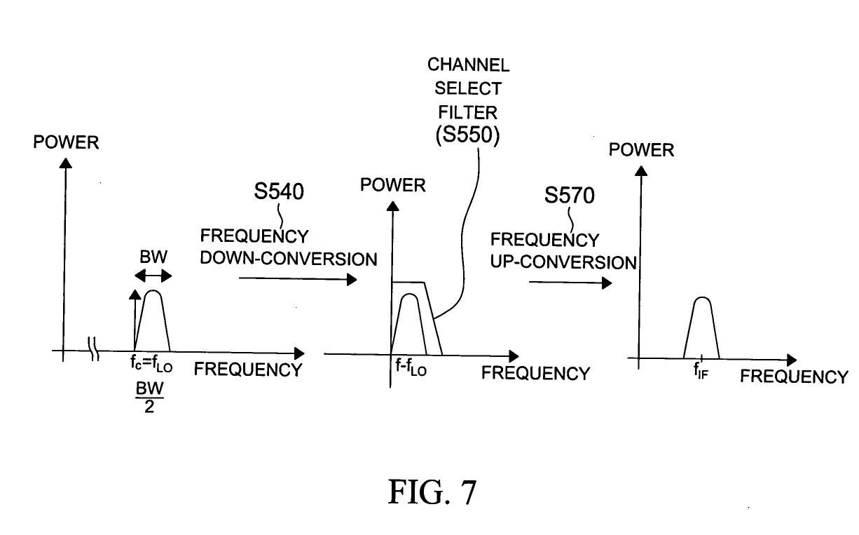

FIG. 7 shows graphs illustrating the process of converting a RF signal into a low IF signal according to an example embodiment of the present invention. Another embodiment of the present invention will be described with reference to the flow chart in FIG. 5. Other embodiments and configurations are also with the scope of the present invention.

If a RF signal is received through the antenna 410, the band select filter 420 may selectively pass only a required frequency band (S510, S520). For example, since a PHS terminal may use the frequency of 1.9 GHz as a carrier frequency, the band select filter 420 may filter only the frequency near the band of 1.9 GHz.

The band-pass-filtered RF signal may be low-noise amplified by the LNA 430 and then down-converted by the down-mixers 440a and 440b (S530, S540). The oscillating frequency for down-converting may be approximate to a center frequency of the received RF signal so that the frequency down-converted becomes a substantially low IF. As shown in FIG. 7, the frequency down-converted may become a substantially low IF by using an oscillating frequency fLOsmaller than the center frequency fC of the received RF signal by bandwidth/2 (=BW/2).

The channel select filters 460a and 460b may have the required channel by filtering a signal whose frequency is down-converted into a substantially low IF with an integrated filter having a low quality factor. In addition, the automatic gain controllers 465a and 465b may amplify the signal filtered by the channel select filter with an appropriate gain (S550, S560).

Similar to the embodiment described above with reference to FIG. 6, the frequency of the amplified signal may be up-converted again by the up-mixers 470a and 470b, and the frequency oscillated from the second local oscillator 475 when up-converting may depend on the input frequency required by the IF processor 490 (S570).

The IMD generated when up-converting the frequency may be removed by the LPF 485, and the IF signal whose frequency is up-converted may be inputted to the IF processor and then processed (S580, S590).

According to embodiments of the present invention, a received RF. signal may be converted into a substantially zero IF or a low IF and then filtered, thereby satisfying the performance of a receiver required as a filter having a low quality factor.

Also, a filter having a low quality factor may be implemented as an integrated filter, thereby enabling a receiver to become much smaller and lighter and reduce its production cost. An integrated filter may easily be changed based on its required specification and performance. A substantially zero IF or a substantially low IF may be used, thereby having an advantage that a separate image reject filter may not be needed in order to remove the image frequency.

Also, a RF signal may be down-converted into a substantially zero IF signal or a substantially low IF signal and then up-converted again into a required IF signal. Thus, the input and output may be the same as the super-heterodyne system, thereby making the wireless receiver compatible with the super-heterodyne interface.

The foregoing embodiments and advantages are merely exemplary and are not to be construed as limiting the present invention. The present teaching can be readily applied to other types of apparatuses. The description of embodiments of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A wireless receiver comprising:
a receiving device to receive a radio-frequency (RF) signal;
a frequency down-converting device to down-convert a frequency of the received RF signal so that a substantial center frequency of the RF signal becomes substantially zero;
a channel select filtering device to select a channel from the down-converted frequency signals and to provide a channel selected signal;
an intermediate-frequency (IF) signal converting device to up-convert a frequency of the channel selected signal into a particular IF;
an IF processing device to extract a baseband signal after the IF signal converting device up-converts the frequency to the particular IF; and
an amplifying device to amplify a signal with a gain during converting the frequency.

2. The wireless receiver of claim 1, wherein the channel select filtering device comprises an integrated filter.

3. The wireless receiver of claim 2, wherein the IF signal converting device comprises:
a local oscillator to provide a signal having a frequency substantially the same as the particular IF;
a phase-locked loop to lock an oscillating frequency of the local oscillator; and
a mixer up-converting a frequency by mixing the channel selected signal with the signal provided by the local oscillator.

4. The wireless receiver of claim 3, wherein the IF signal converting device further comprises an integrated filter removing intermodulation distortion (IMD) provided by the mixer.

5. A wireless receiver comprising:
a receiving device to receive a radio frequency (RF) signal;
a frequency down-converting device to down-converting a frequency of the received RF signal so that a substantially center frequency of the RF signal becomes a substantially low intermediate-frequency (IF) near zero;
a channel select filtering device to select a particular channel from the down-converted frequency and to provide a channel selected signal;
an IF signal converting device to up-convert a frequency of the channel selected signal into a particular IF;
an IF processing device to extract a baseband signal after the IF signal converting device up-converts the frequency to the particular IF; and
an amplifying device to amplify a signal with a gain during converting the frequency.

6. The wireless receiver of claim 5, wherein the channel select filtering device comprises as an integrated filter.

7. The wireless receiver of claim 6, wherein the IF signal converting device comprises:
a local oscillator to provide a signal having a frequency substantially similar to the particular IF;
a phase-locked loop to lock an oscillating frequency of the local oscillator; and
a mixer to up-convert a frequency by mixing the channel selected signal with the signal provided by the local oscillator.

8. The wireless receiver of claim 7, wherein the IF signal converting device further comprises an integrated filter removing intermodulation distortion (IMD) provided by the mixer.

9. The wireless receiver of claim 7, wherein the frequency provided by the local oscillator is substantially the same as a value provided by subtracting the low IF from the particular IF.

10. The wireless receiver of claim 5, wherein the receiver is provided in a Personal Handyphone System (PHS) or a Bluetooth system.

11. A wireless receiver comprising:
an antenna to receive a radio-frequency (RF) signal;
a band select filter to select a particular band in the received RF signal;
an amplifier to amplify the band selected signal;
a frequency down-converter to convert the amplified RF signal into a substantially zero intermediate frequency (IF) signal or a substantially low IF signal;
an integrated channel select filter to select a particular channel from the down-converted frequency signal and to provide a channel selected signal;
an automatic gain controller to control a gain of the channel selected signal;
a frequency up-converter to up-convert a frequency of the channel selected signal into a particular IF signal; and
an IF processor to extract a baseband signal after the frequency up-converter up-converts the signal into the particular IF.

12. The wireless receiver of claim 11, wherein the frequency up-converter comprises:
a local oscillator to provide a signal having a frequency for up-converting the substantially zero IF signal or the substantially low IF signal into the particular IF signal;
a phase-locked loop to lock an oscillating frequency of the local oscillator; and
a mixer to up-convert a frequency by mixing the channel selected signal with the signal provided by the local oscillator.

13. The wireless receiver of claim 12, wherein the frequency up-converter comprises an integrated filter to remove intermodulation distortion (IMD) provided by the mixer.

14. The wireless receiver of claim 12, wherein an oscillating frequency of the local oscillator is substantially the same as the frequency of the particular IF.

15. The wireless receiver of claim 12, wherein an oscillating frequency of the local oscillator is a value provided by subtracting the low IF from the particular IF.

16. The wireless receiver of claim 11, wherein the receiver is provided within a Personal Handyphone System (PHS) or a Bluetooth system.

17. A wireless receiving method using a substantially zero intermediate frequency (1F) comprising:
receiving a radio-frequency (RF) signal;
down-converting a frequency so that a substantially center frequency of the received RF. signal becomes substantially zero;
selecting a particular channel from the down-converted frequency signal and providing a converted selected signal;
up-converting a frequency of the channel selected signal into a particular IF;
extracting a baseband signal from the up-converted frequency signal; and
amplifying a signal with a gain during converting the frequency.

18. The wireless receiving method of claim 17, wherein selecting the particular channel is implemented by an integrated filter.

19. The wireless receiving method of claim 18, wherein the up-converting comprises:
oscillating a signal having a substantially same frequency as the particular IF;
locking the oscillated frequency using a phase-locked loop; and
mixing the channel selected signal with the oscillated signal.

20. The wireless receiving method of claim 19, wherein the up-converting further comprises filtering to remove intermodulation distortion (IMD) provided in the mixing using an integrated filter.

21. A wireless receiving method using a substantially low intermediate-frequency (IF) comprising:
receiving a radio-frequency (RF) signal;
down-converting a frequency so that a substantially center frequency of the RF signal becomes a substantially low IF;
selecting a particular channel from the signals whose frequency is down-converted and providing a channel selected signal;
up-converting a frequency of the channel selected signal into a particular IF;
extracting a baseband signal from the up-converted frequency signal; and
amplifying a signal with a gain during converting the frequency.

22. The wireless receiving method of claim 21, wherein the up-converting is implemented by an integrated filter.

23. The wireless receiving method of claim 22, wherein the up-converting comprises:
oscillating a signal having substantially the same frequency as the particular IF;
locking the oscillated frequency using a phase-locked loop; and
mixing the channel selected signal with the oscillated signal.

24. The wireless receiving method of claim 23, wherein the up-converting further comprises filtering to remove intermodulation distortion (IMD) provided during the mixing using an integrated filter.

25. The wireless receiving method of claim 23, wherein a frequency oscillated in the oscillating is provided as a value of subtracting the low IF from the particular IF.

26. The wireless receiving method of claim 21, wherein the receiving method is provided in a Personal Handyphone System (PHS) or a Bluetooth system.

27. A wireless receiving method comprising:
receiving a radio-frequency (RF) signal;
selecting a particular band in the received RF signal;
low-noise amplifying the band selected signal;
down-converting the low-noise amplified RF signal into a substantially zero intermediate-frequency (IF) signal or a substantially low IF signal;
selecting a particular channel from the signals whose frequency is down-converted and providing a channel selected signal;
controlling a gain of the channel selected signal;
up-converting the channel selected signal into a particular IF signal; and
extracting a baseband signal after up-converting the channel selected signal into the particular IF signal.

28. The wireless receiving method of claim 27, wherein the up-converting comprises:
oscillating a signal having a frequency for up-converting the substantially zero IF signal or the substantially low IF signal into the particular IF signal;
locking the oscillated frequency using a phase-locked loop; and
mixing the channel selected signal with the signal oscillated during the oscillating frequency.

29. The wireless receiving method of claim 28, wherein the up-converting further comprises filtering to remove intermodulation distortion (IMD) provided in the mixing using an integrated filter.

30. The wireless receiving method of claim 28, wherein an oscillating frequency is defined as a substantially same frequency as the particular IF.

31. The wireless receiving method of claim 28, wherein an oscillating frequency is defined as a substantially same value as subtracting the substantially low IF from the particular IF.

32. The wireless receiving method of claim 27, wherein the receiving method is applied to a Personal Handyphone System (PHS) or a Bluetooth system.
